(19) United States
(12) Patent Application Publication
(10) Pub. No.: US 2017/0228907 A1
(43) Pub. Date: Aug. 10, 2017

(54) Method of Carrying Out Land Based Projects Using Aerial Imagery Programs

(71) Applicant: Andrew Niemczyk, Hazel Park, MI (US)

(72) Inventor: Andrew Niemczyk, Hazel Park, MI (US)

(21) Appl. No.: 15/433,527

(22) Filed: Feb. 15, 2017

Related U.S. Application Data
(63) Continuation of application No. 14/631,996, filed on Feb. 26, 2015, now abandoned.
(60) Provisional application No. 61/945,310, filed on Feb. 27, 2014.

(51) Int. Cl. G06T 11/60; G06F 3/0482; G06T 11/00; G06F 3/0484

(52) U.S. Cl. CPC G06T 11/60; G06F 3/04845; G06F 3/0482; G06T 11/001; G06T 2200/24

(57) ABSTRACT

A method of enhancing existing aerial image programs by adding capabilities thereto including a program feature enabling a user to add a series of markers along a line drawn by the user on to an aerial image at a user selected spacing, and to enable calculations related to the number of markers for facilitating a user selected project type.

### CROSS REFERENCE TO RELATED APPLICATIONS

This application is a continuation in part of U.S. patent application Ser. No. 14/631,996 filed on Feb. 26, 2015, and claims the benefit of U.S. provisional application No. 61/945,310 filed on Feb. 27, 2014.

### BACKGROUND OF THE INVENTION

This application concerns facilitating planning of various projects carried out on land areas.

The present inventor has developed a way to enhance the percolation of surface water into the ground, involving drilling a series of hole patterns into the ground along a path and installing tubular passive pumps into the drilled holes of varying length.

See U.S. Pat. No. 8,562,250 issued to the present inventor for further information.

In carrying out such projects a layout drawing of the array of holes must be prepared for the purpose of determining the number and location of holes to be drilled into the ground and counting the number of passive pumps needed in order to determine how many pumps are needed to carry out the project.

Such projects often involve laying out the project on a drawing so as to determine the material requirements of the project, such as the quantity of material needed the number of components required, etc such as the quantity of paving material must to be determined, or for building fences in which the number of posts required must be determined.

Such a prior art layout drawing involving that invention is depicted in FIG. 1 in which tubular pump arrays 10A, 10B, 10C, 10D, 10E and 10F are shown installed in holes drilled into the ground. The tubular passive pump arrays 10F-10F are typically located to avoid some existing features such as trees 12, paved areas 14 and buildings 16.

The arrays are drawn in their proper location and the number of tubular pumps necessary are totaled up by counting the number of pumps on the drawing.

Other uses would include paving, building decks, and fertilizing ground areas.

Existing aerial image programs are available, arguably the most well known websites being Google Earth and Google Earth Pro provided by Google, Inc. accessed via computer, smart phones, tablets. These programs enable images of a user selected areas of the earth's surface to be displayed as on a monitor, with a line able to be electronically drawn by a user as with use of a mouse, to define the boundary of a region of interest to the user lying within the image of a larger area. The user draws the line at varying speeds and Google Earth generates points which are spaced apart at varying distances, again depending on the speed at which each segment of the line is drawn.

The total length of a drawn line can be measured by these existing programs. In addition, the line can define a closed area of any selected shape. The Google Earth program can calculate the area so defined by a user, converting the same to a polygonal areas added up to allow the total area to be computed and displayed.

Altimeters can also be provided on a drone to obtain altitude information. Such drone camera images allow images to be generated for analysis. Other technologies have been developed which use photographs taken by camera mounted on a drone.

It would be of help to persons planning land area based projects if such calculations could be carried out by an aerial image program itself in order to quickly determine the requirements of such a project.

It is the object of the present invention to add an integrated capability to an aerial image program for creating a project layout and determining requirements of a given project on such aerial image.

### SUMMARY OF THE INVENTION

The above recited object and other objects which will be appreciated by those skilled in the art are achieved by adding an integrated program improvement to Google Earth or other similar aerial imaging programs which will assist and expedite planning a project. Such added program provides an ability for a user to create display of a series of graphic markers of any of various configurations such as small boxes, and/or colors at any user selected spacing in any selected measurement units along a line drawn by the user on the image delineated by the user. This enables the user to quickly determine the total number of components required, corresponding to the total number of markers. This added capability also can also be itself the capable of counting the total number of markers spaced along the entire line or any segment thereof. The markers could each correspond to a grouping of such features such as drilled hole patterns and tubular pumps used on the type of project described above.

As noted above, the shape and color of the markers along the complete length of the line or any segment of the line can also be selected by the user so as to be able to highlight certain sections of the line of markers which represent other features.

Another added programmed capability according to the present invention is the ability to calculate the requirements of various types of projects carried out in any image area delineated by the user such as to carry out a paving project, i.e., the total volume of material needed for paving an area of a user selected thickness in the case of continuous paving. This enables a user to quickly determine the total volume of materials such as poured concrete, asphalt or the like needed to carry out the project. Also, the number of paving bricks or stones for a noncontinuous pavement needed for paving a delineated subregion may be calculated by the aerial imaging project.

Other land area based calculations include an ability to calculate the number of board feet of lumber necessary to construct a deck; or the amount of fertilizer necessary to be applied at a selected concentration to a delineated lawn or field area.

Thus, the usefulness of the aerial image program itself can significantly enhanced for the benefit of contractors, homeowners or others since these added capabilities may eliminate the need for making measurements in the field and for preparing layout drawings.

### DESCRIPTION OF THE DRAWINGS

FIG. 1 is a view of a layout drawing prepared in the conventional way in the course of planning a surface water control installation as described above.

FIG. 2 is a plan view drawing of a typical Google Earth™ aerial image with a defined area of interest delineated by a line electronically drawn by the user and a notation relating to the addition of equally spaced markers at a user selected uniform spacing.

FIG. 2A is a plan view of the area as shown in FIG. 2 with equispaced marker small square markers added along the delineated line by an added feature of the aerial image program.

FIG. 3 is a drawing of a screen shot of a window generated by the enhanced aerial image program enabling the selection of the spacing of the line of markers.

FIG. 4 is a drawing of a screen shot of a window generated by the enhanced aerial image program enabling selection of the dimensional units of the marker spacing.

FIG. 5 is a drawing of a screenshot of a window according to the enhanced aerial image program enabling selection of display appearance characteristics of the series of markers.

FIG. 6 is a drawing of a screenshot of a window generated by the enhanced aerial image program enabling compilation of the total volume of an area if a selected depth within a defined area of an aerial image.

FIG. 7 is a drawing of a screenshot of a window showing features enabling the selection of a type project by a user and the user inputs necessary to carry out a selected project and the results all generated by an enhanced aerial image program.

FIG. 8 is a diagram representing various building construction projects facilitated by use of the enhanced aerial image program according to the invention.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

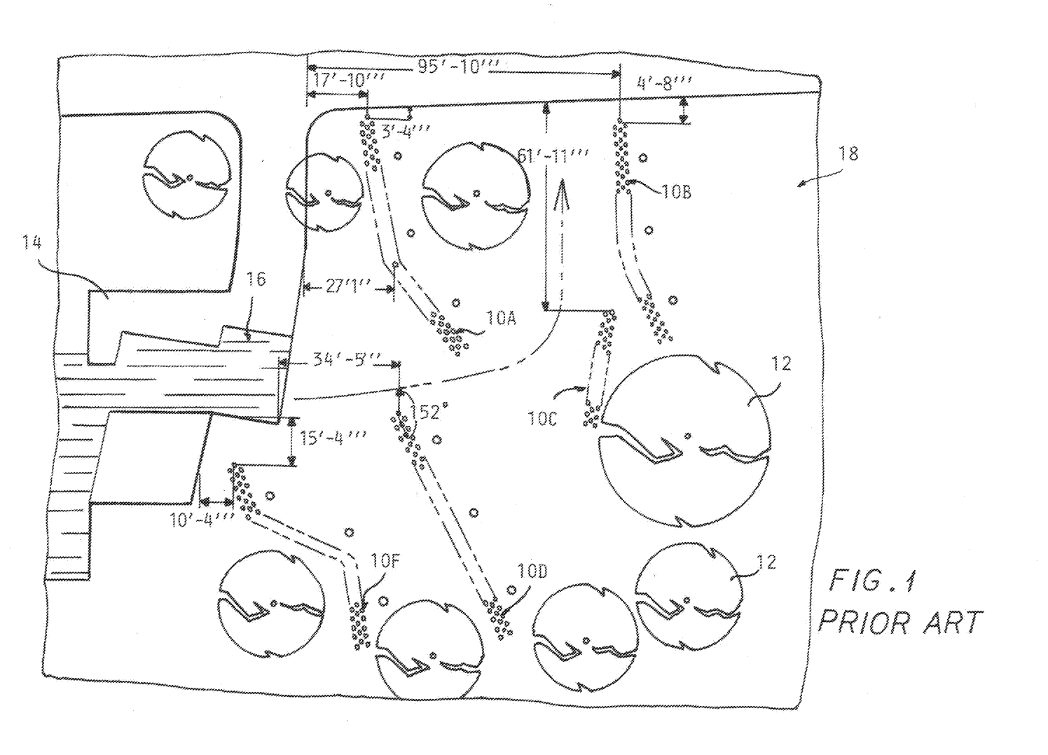

Referring to FIG. 1, a partial layout drawing 18 is depicted, prepared by conventional drafting programs or manually drawn. Such features as trees 12, pavement areas 14, and buildings 16 are shown. Such a drawing is associated with the installation of several arrays 10A-10F of tubular passive pumps represented by the small circles drawn therein, inserted in holes first drilled into the ground, as described in U.S. Pat. No. 8,562,250 issued to the present inventor.

The location and configuration of those arrays is determined by a hydrological analysis and must be laid out prior to their installation. The development of such drawings require substantial time and effort by personnel working on such a project.

Once the layout drawing is prepared, the number of holes and passive tubular pumps must be determined by an inspection of the drawing 10 and a manual count or calculation.

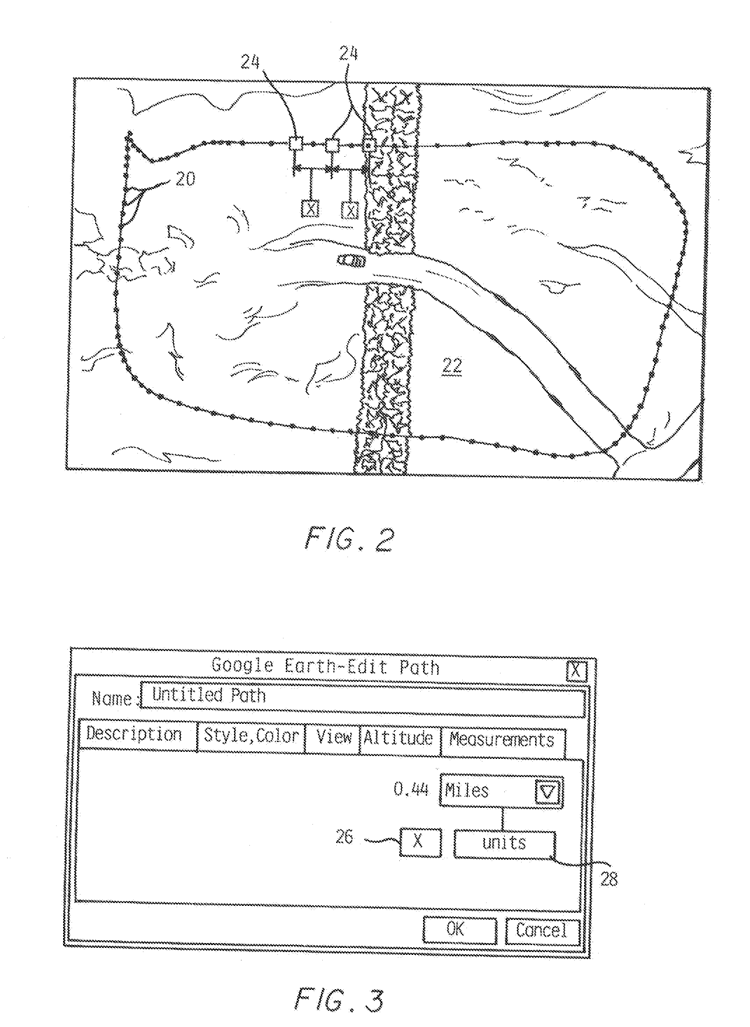

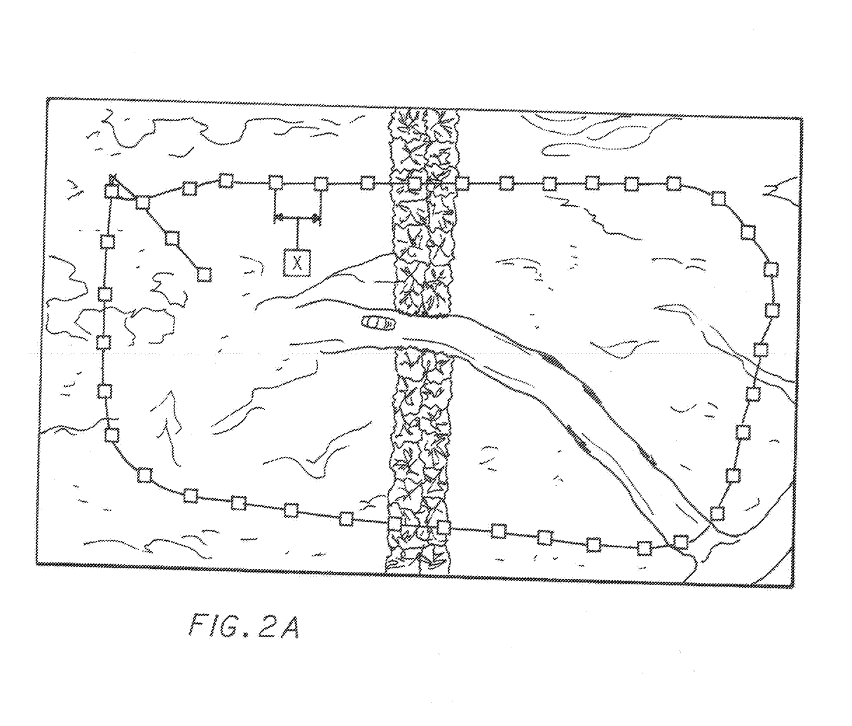

Referring to FIG. 2, a drawing is shown derived from an aerial image of a particular land area obtained from such geographical information programs as Google Earth™, and Google Earth Pro, a virtual geographical program (originally called Earth Viewer 3D) which was acquired by Google Inc. of Mountain View Calif. Imaging is currently offered free to the public, accessed via the internet by means of a computer or other device such as a smart phone, tablet, etc.

The aerial images so obtained show an area of the earth's surface including various salient features, i.e., structures, landscapes, roads, bodies of water, etc.

Google Earth has the capability of allowing users to electronically draw a line as by use of a mouse. The line may completely circumscribe and delineate an area 22 of interest within the displayed image, with a series of equally spaced marked electronically by the Google Earth program or other aerial imaging program. The marks 20 are spaced in each segment in correspondence with the speed which the user draws that segment of the line. The existing program has a capability to measure the total length of such a boundary line.

According to the present invention such aerial image geographic programs are enhanced by integration therewith of suitable routinely written software enabling a user to add to such image a series of selected electronic markers 24, such as the small squares shown, at a selected constant spacing X along the entire line 18 drawn by the user or along any selected segment thereof.

The markers 24 are added spaced apart at a user selected spacing distance X, which may be selected by the user using the box 26 and expressed in a selected length unit (feet, meters) entered in box 28 as indicated in the program windows of FIGS. 3 and 4, which spacing distance X is selected by the user entering the spacing in the box 26 in units selected in box 28.

The marker's style, color, description may be selected by the user.

FIG. 4 shows an alternate wording of the selection windows.

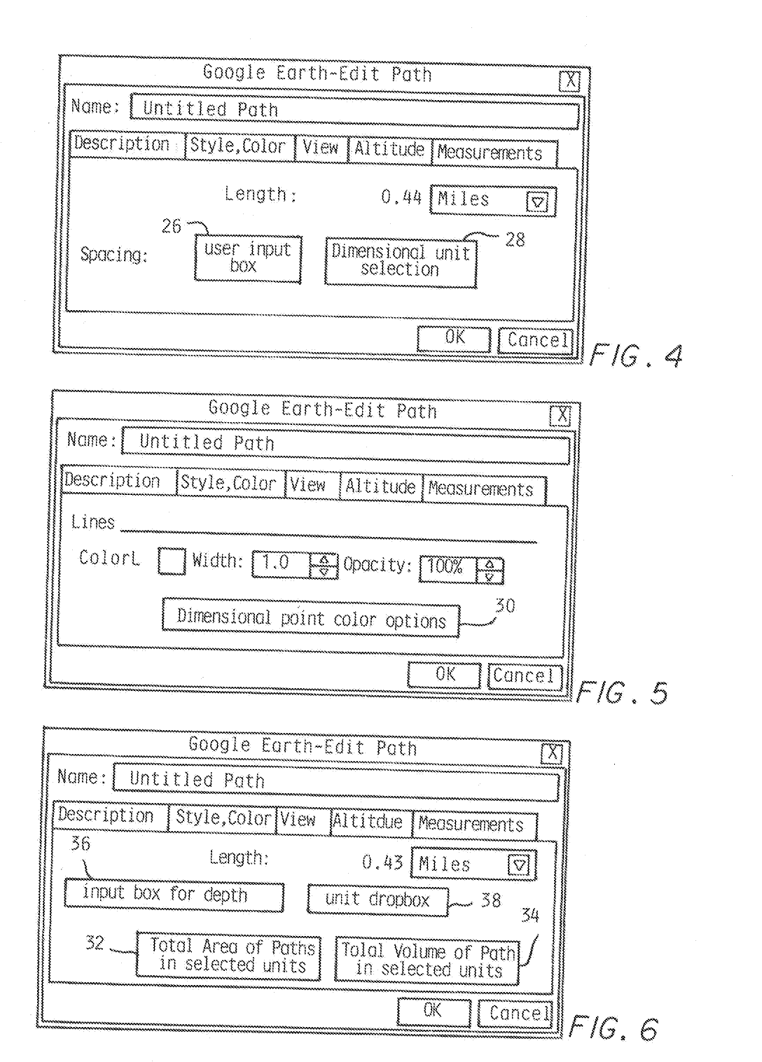

FIG. 5 shows a program selection window which allows a user to select a particular color for any of the markers 24 by checking of the box 30.

FIG. 6 shows a program window enabling calculation of the total land area within a given boundary line and also the volume of solid paving required with respect to the marked area, seen in boxes 32, 34, with a length unit selection made with box 38.

The user specifies a depth of paving using box 36 when such a paving volume calculation is desired, as for determining the total volume of paving material required by a project.

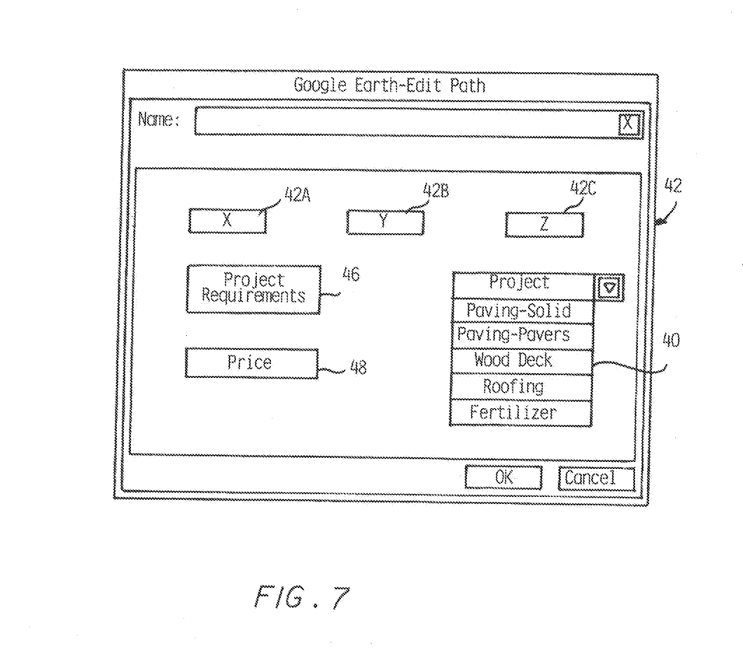

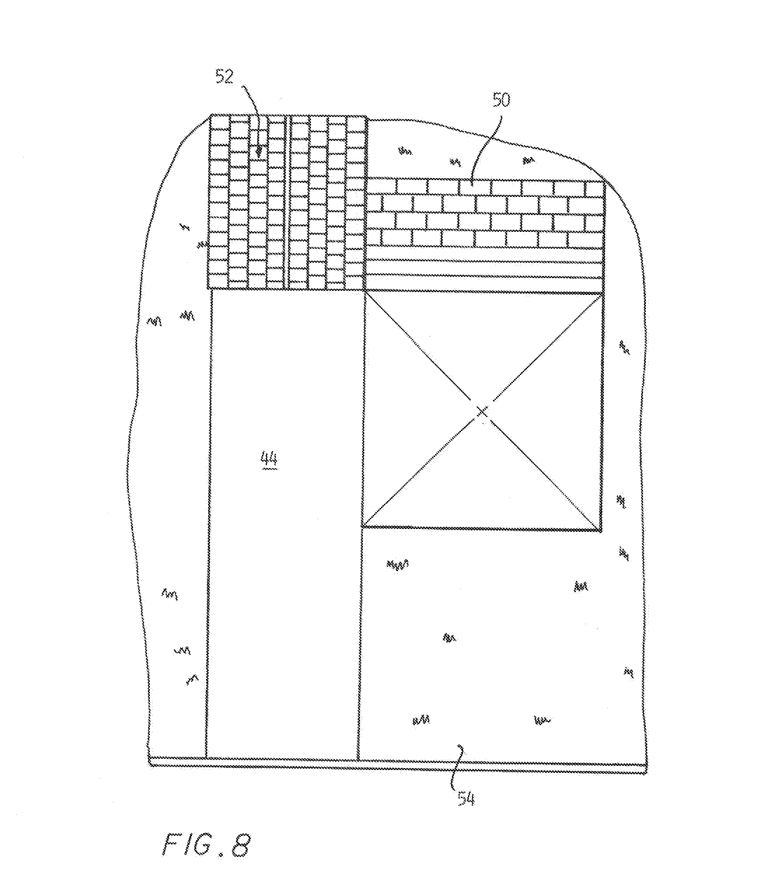

FIGS. 7 and 8 relate to a program modification involving selection of a number of projects set out in a drop down window 40 of a program window 42.

Three input windows 42A, B, C are used for inputting information by the user, these inputs varying depending on the project selected.

For solid paving, as is done in the driveway area 44 depicted in the diagram of FIG. 8, a depth selection Z can be set as by using box 42. Using that value and a computed area, the total volume of material (i.e. concrete or asphalt) is calculated and displayed in box 46.

For a paver type paving project that is to be done in area 50 in the diagram of FIG. 8, the user inputs the length and width of the pavers in windows 42A, 42B (X and Y) of FIG. 7, and the number of pavers required will be calculated and that number is displayed in window 46.

If desired, a total cost of materials can be calculated if the user inputs the cost per paver as by using window 42C (Z) the displayed in window 48.

For a wood deck 50, the user inputs the lumber width as in window 42A (X) and the program determines the number of pieces in window 48.

For a roofing project, the user can input the pitch of the roof 52 if known using window 42C (Z) and the number of shingles (or bundles) is calculated and displayed in window 46.

Finally, the quantity of fertilizer needed for the lawn or field area 54 can be calculated after the user inputs the rate of application, as total pounds of fertilizer required calculated and displayed in window 46.

Accordingly, the utility of Google Earth, Google Earth Pro or similar geographical information program is significantly enhanced for the use of contractors, builders, homeowners, etc. in carrying out projects of the type described.

1. A method of enhancing an existing aerial image program enabling a user to draw a line on an aerial image produced by the existing program comprising adding an integrated capability of enabling a user to selectively mark points at an user selected uniform spacing along the entire line A drawn on said aerial images produced by said aerial image program or along any selected segment.

2. The method according to claim 1 wherein said integrated program enhancement feature enables a user to select a marker style for the entire length or any selected segment of said line drawn by a user of said aerial image program.

3. The method according to claim 2 wherein said marker style comprises the shape of said markers.

4. The method according to claim 2 wherein said integrated program enhancement markers can enable a user to select a color of said markers for any segment of said line drawn by said user.

5. The method according to claim 2 wherein said integrated program enhancement enables adding up the total number of said markers along the entire length of said drawn line or any segment of said line.

6. The method according to claim 3 wherein said integrated program enhancement enables a user to select from drop down list of project types and make calculations corresponding to said selected project type.

7. The method according to claim 6 wherein said listing of projects includes continuous paving, paving with pavers, decking, roofing or fertilizing lawn or field areas.
